(19) United States
(12) Patent Application Publication
(10) Pub. No.: US 2006/0106968 A1
(43) Pub. Date: May 18, 2006

(54) Intelligent platform management bus switch system

(76) Inventor: Gary Chee Wooi Teoh, Batu Ferringhi (MY)

Correspondence Address: Grossman, Tucker, Perreault & Pfleger, PLLC;PortfolioIP, P.O. Box 52050, Minneapolis, MN, 55402, US

(21) Appl. No.: 10/989,127

(22) Filed: Nov. 15, 2004

(51) Int. Cl. G06F 13/00

(52) U.S. Cl. 710/316

(57) ABSTRACT

A method according to one embodiment may include routing information between a plurality of Intelligent Platform Management (IPM) controllers utilizing an intelligent platform management bus (IPMB) switch system. The IPMB switch system may comprise a first and second IPMB switch. The first IPMB switch may be coupled to each of the plurality of IPM controllers via a first associated plurality of IPMB links, and the second IPMB switch may be coupled to each of the plurality of IPM controllers via a second associated plurality of IPMB links. Of course, many alternatives, variations, and modifications are possible without departing from this embodiment.

### FIELD

This disclosure relates to an intelligent platform management bus switch system.

### BACKGROUND

As computer systems and online services continue to grow, complex server equipment has been developed. It is desirable to autonomously monitor and control such server equipment. Monitored conditions may include those condition related to the health of the system hardware such as board voltages, temperatures, fan rotation speed, processor and bus failures, fan failure, etc. To autonomously monitor and manage such server equipment, server management systems have been developed.

Such server management systems may utilize a single dedicated intelligent platform management bus to route data and/or commands among a plurality of controllers within a chassis server system. Some controllers may be on different circuit boards within the chassis server system. One disadvantage of this single dedicated bus is that messages between the controllers cannot be automatically routed from one controller to another should a controller of a particular board wish to communicate with a controller of another board in the system. In addition, there is little fault tolerance in such a system since if the single dedicated bus fails, communication between controllers is thwarted. Furthermore, there is little flexibility to incorporate value added communication services between controllers in such a single dedicated bus system.

### BRIEF DESCRIPTION OF THE DRAWINGS

Features and advantages of embodiments of the claimed subject matter will become apparent as the following Detailed Description proceeds, and upon reference to the Drawings, where like numerals depict like parts, and in which:

FIG. 1 is a block diagram of computer system including an intelligent platform management bus (IPMB) switch system consistent with an embodiment;

FIG. 2A is a block diagram of one embodiment of the IPMB switch system of FIG. 1 having a star topology;

FIG. 2B is a block diagram of another embodiment of the IPMB switch system of FIG. 1 having a dual star topology;

FIG. 2C is a block diagram of another embodiment of the IPMB switch system of FIG. 1 having a dual-dual star topology;

FIG. 3 is a block diagram of one switch of the IPMB switch system of FIGS. 2A-2C;

FIG. 4 is an exemplary table that may be stored in memory and utilized by the switch system of FIGS. 2A-2C;

FIG. 5 is a block diagram of the topology of FIG. 2C segmented into two zones of IPM controllers;

FIG. 6 is a flow chart illustrating operational flow of the switch system of FIG. 2C; and

FIG. 7 is a flow chart illustrating operations that may be performed according to an embodiment.

Although the following Detailed Description will proceed with reference being made to illustrative embodiments, many alternatives, modifications, and variations thereof will be apparent to those skilled in the art. Accordingly, it is intended that the claimed subject matter be viewed broadly.

### DETAILED DESCRIPTION

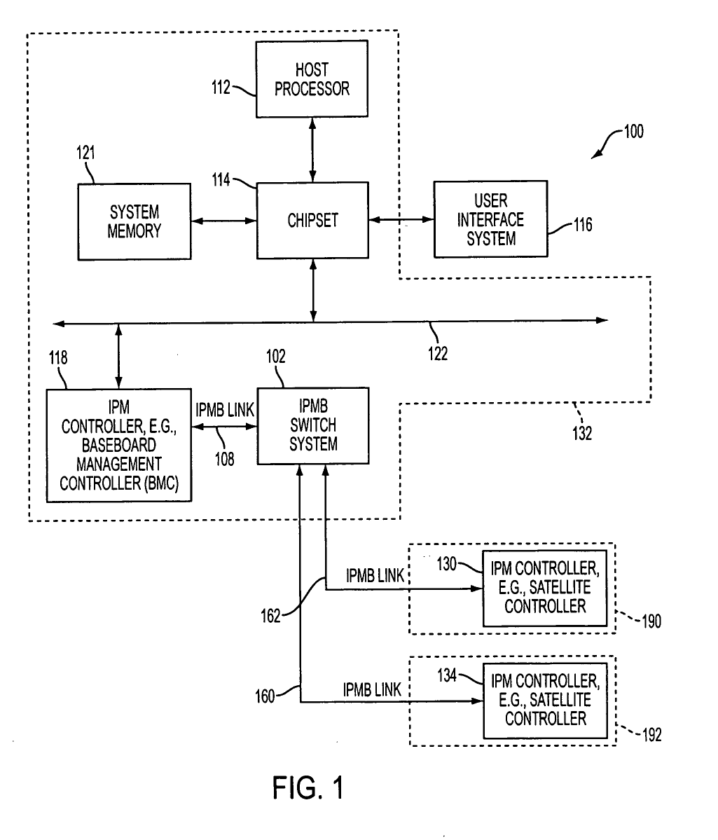

FIG. 1 illustrates a system embodiment 100 of the claimed subject matter. In one embodiment, the system 100 may be a server chassis system capable of supporting a plurality of circuit boards 132, 190, 192. Circuit boards 132, 190, 192 may be arranged, for example, in a rack or pedestal configuration. The system 100 may comprise a switch system 102 capable of routing information between one or more intelligent platform management (IPM) controllers such as IPM controllers 118, 130, and 134.

The system 100 may also include a user interface system 116 that may include one or more devices for a human user to input commands and/or data and/or to monitor the system 100 such as, for example, a keyboard, pointing device, and/or video display. The system 100 may also include a host processor 112, a system bus 122, a chipset 114, system memory 121, a IPM controller 118 that may include a baseboard management controller (BMC), an intelligent platform management bus (IPMB) switch system 102, and other IPM controllers 130, 134, which may be referred to as satellite controllers if distributed on other circuit boards 190, 192 within the system 100.

The host processor 112 may include one or more processors known in the art such as an Intel® Pentium® IV processor commercially available from the Assignee of the subject application. The system bus 122 may include various bus types to transfer data and commands. For instance, the system bus 122 may comply with the Peripheral Component Interconnect (PCI) Express™ Base Specification Revision 1.0, published Jul. 22, 2002, available from the PCI Special Interest Group, Portland, Oreg., U.S.A. (hereinafter referred to as a “PCI Express™ bus”). The system bus 122 may alternatively comply with the PCI-X Specification Rev. 1.0a, Jul. 24, 2000, available from the aforesaid PCI Special Interest Group, Portland, Oreg., U.S.A. (hereinafter referred to as a “PCI-X bus”).

The chipset 114 may include a host bridge/hub system (not shown) that couples the processor 112, system memory 121, and user interface system 116 to each other and to the bus 122. Chipset 114 may include one or more integrated circuit chips, such as those selected from integrated circuit chipsets commercially available from the assignee of the subject application (e.g., graphics memory and I/O controller hub chipsets), although other integrated circuit chips may also, or alternatively be used. The processor 112, system memory 121, chipset 114, bus 122, and switch system 102 may be on one circuit board 132 such as a system motherboard. Alternatively, the switch system 102 may be located elsewhere in the system.

To alleviate processor 112 requirements and to assist with the need for total server availability, Intel, Hewlett-Packard, NEC, and Dell developed the Intelligent Platform Management Interface (IPMI) Standard detailed in “Intelligent Platform Management Interface Specification Second Generation,” Document Revision 1.0, dated Feb. 12, 2004, published by Intel, Hewlett-Packard, NEC, and Dell.

With IPMI, the processor 112 may make requests and receive information from an event log through the BMC. The processor 112 may inquire about changes in the event log since the previous inquiry. With IPMI, use of the processor 112 may be minimized to allow overall system performance improvements. The IPMI Standard may therefore provide a cost-effective and efficient way for the processor 112 to communicate with and monitor a plurality of devices.

The IPM controller 118 which may be a BMC may provide a plurality of platform management functions. For example, the BMC may be coupled to the system 100 via a system interface to the system bus 122 enabling the processor 112 to communicate with the BMC as appropriate. The BMC may also be responsible for monitoring and managing the motherboard 132. This may include, for example monitoring temperature, voltage, fans, power and reset controls, etc. for the motherboard 132. The BMC may also communicate with one or more other IPM controllers 130 and 134 such as satellite controllers on different circuit boards 190, 192.

IPM controllers 130, 134 may, similar to the BMC, be responsible for monitoring one or more conditions of one or more subsystems or modules of the system 100. These subsystems may include redundant power supplies, hot-swap redundant array of independent disk (RAID) drive slots, expansion I/O slots, etc. The IPM controllers 130, 134 may monitor one or more conditions and components such as temperature, voltage, fans, power and reset controls for their particular subsystem.

The IPM controllers 118, 130, 134 may communicate information with each other via a plurality of intelligent platform management bus links 108, 162, 160 coupled to the IPMB switch system 102. Communication between IPM controllers 118, 130, and 134 via the intelligent platform management bus links may comply or be compatible with the “Intelligent Platform Management Bus Communications Protocol Specification,” Document Revision 1.0, dated Nov. 15, 1999, published by Intel, Hewlett-Packard, NEC, and Dell and/or later versions of this standard. The IPMB Standard specifies the architecture and protocol used to interconnect IPM controllers via an I²C based serial bus for the purpose of platform management. Details on the I²C-bus are detailed in “The I²C-BUS SPECIFICATION,” Version 2.1, dated January 2000, published by Phillips Semiconductors.

In one embodiment, the IPMB switch system 102 may be coupled to the IPM controller 118 via IPMB link 108. The IPMB switch system 102 may also be coupled to IPM controller 130 via IPMB link 162. Furthermore, the IPMB switch system 102 may also be coupled to IPM controller 134 via IPMB link 160.

Although in this embodiment, three IPM controllers 118, 130, 134 and three IPMB links 108, 162, 164 are illustrated, any plurality of IPMB links and/or IPM controllers may be coupled to the IPMB switch system 102 without departing from this embodiment. The IPMB switch system 102 may be capable of routing information among the plurality of IPM controllers coupled to the IPMB switch system 102.

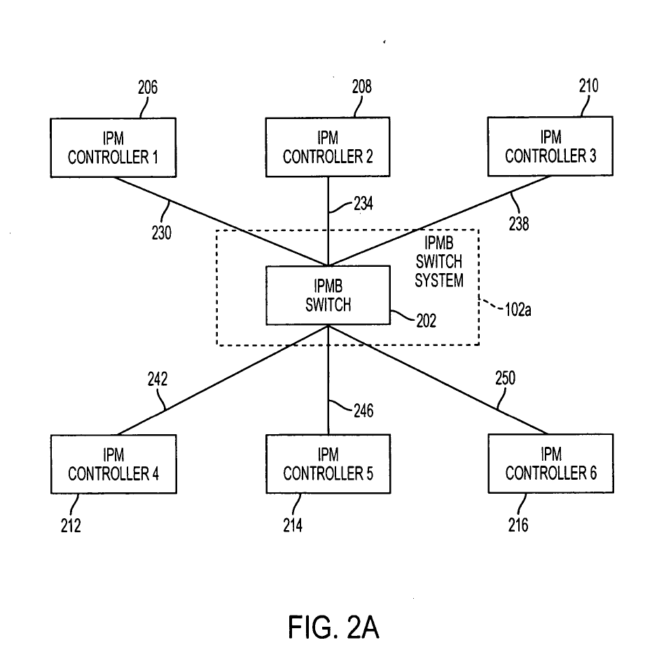

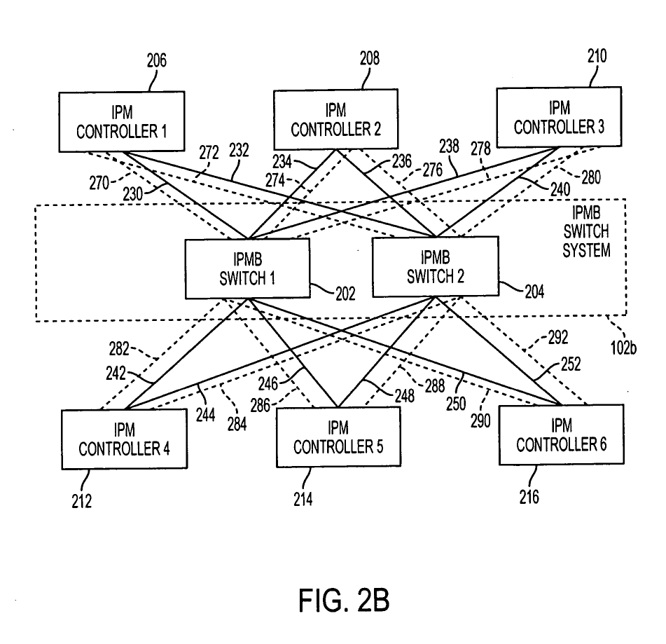

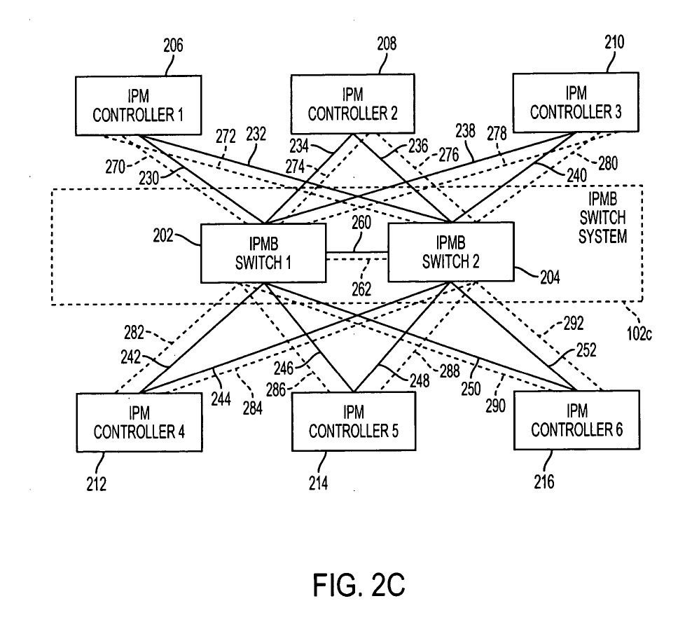

FIG. 2A is a block diagram of one embodiment 102a of the IPMB switch system of FIG. 1 having a star topology. The switch system 102a may include one IPMB switch 202 at the center of the “star” by coupling each IPM controller 206, 208, 210, 212, 214, 216 in the system to the IPMB switch 202 via respective IPMB links 230, 234, 238, 242, 246, and 250. The IPMB switch 202 may be capable of routing information between the plurality of IPM controllers 206, 208, 210, 212, 214, 216.

FIG. 2B is a block diagram of another embodiment 102b of the IPMB switch system of FIG. 1 having a dual star topology. The dual star topology may include two IPMB switches 202 and 204 at the center of the “star” by coupling each IPM controller 206, 208, 210, 212, 214, 216 in the system to each IPMB switch 202 and 204 via an associated plurality of IPMB links. For example, IPM controllers 206, 208, 210, 212, 214, 216 may be coupled to the first IPMB switch 202 via an associated plurality of IPMB links 230, 234, 238, 242, 246, and 250. Meanwhile, the IPM controllers 206, 208, 210, 212, 214, 216 may be coupled to the second IPMB switch 204 via another associated plurality of IPMB links 232, 236, 240, 244, 248, and 252.

An optional dual set of IPMB links may also couple each IPM controller to each IPMB switch 202, 204. For example, IPM controllers 206, 208, 210, 212, 214, 216 may be coupled to the first IPMB switch 202 via a associated plurality of IPMB links 270, 274, 278, 282, 286, and 290 that are redundant to the plurality of IPMB links 230, 234, 238, 242, 246, and 250. Meanwhile, the IPM controllers 206, 208, 210, 212, 214, 216 may also be coupled to the second IPMB switch 204 via a plurality of IPMB links 272, 276, 280, 284, 288, and 292 that are redundant to the plurality of IPMB links 232, 236, 240, 244, 248, and 252.

FIG. 2C is a block diagram of yet another embodiment 102c of the IPMB switch system of FIG. 1 having a dual-dual star topology. The dual-dual star topology of FIG. 2C is similar to that of FIG. 2B with the addition of another IPMB link 260 coupling the first IPMB switch 202 to the second IPMB switch 204. Another link 262 redundant to the link 260 may also couple the first IPMB switch 202 to the second IPMB switch 204.

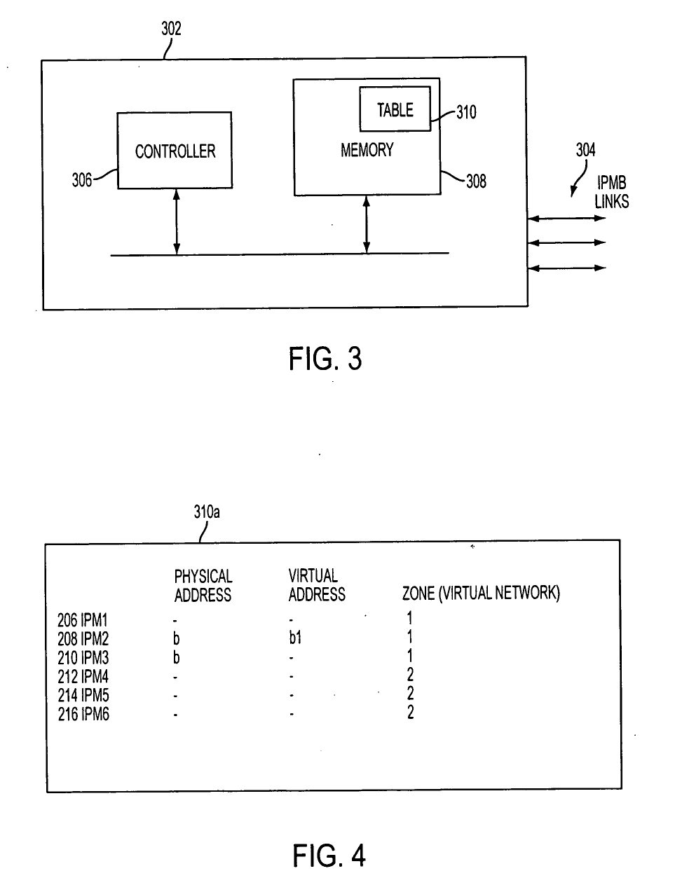

FIG. 3 is a block diagram of one embodiment of one IPMB switch 302 which may be utilized in one of the IPMB switch systems of FIGS. 2A through 2C. The switch 302 may be implemented in hardware as an application specific integrated circuit (ASIC) or a field programmable gate array (FPGA) that can be programmed in the field after manufacture. The IPMB switch 302 may be coupled to various IPM controllers via an associated plurality of IPMB links 304. The IPMB switch 302 may include a controller 306 and memory 308. The controller 306 may control operation of the IPMB switch 302. The controller 306 may receive an IPMI message from one of the IPM controllers and analyze a portion of the message for routing information. As a result of at least in part that analysis, the controller 306 may then selectively route the IPMI message to one or more destination IPM controllers.

The controller 306 may utilize a memory structure, e.g., a table 310, stored in memory 308 of the IPMB switch 302. Memory 308 may include one or more machine readable storage media such as random-access memory (RAM), dynamic RAM (DRAM), static RAM (SRAM) magnetic disk (e.g. floppy disk and hard drive) memory, optical disk (e.g. CD-ROM) memory, and/or any other device that can store information. Although memory 308 is illustrated as being internal to the switch 302, such memory may also be located external to the switch as long as such memory is accessible to the controller 306.

In any of the star, dual star, or dual-dual star topologies of FIGS. 2A through 2C, IPMI messages may be routed to a destination IPM controller by the IPMB switch system. To accomplish such routing to various IPM controllers 206, 208, 210, 212, 214, 216, the IPMB switch system 102 may construct an address table for each IPM controller 206, 208, 210, 212, 214, 216 in the system and then access this address table, e.g., table 310, to determine, at least in part, the address of the destination IPM controller in response to a routing portion of the incoming IPMI message.

FIG. 4 is one embodiment 310a of the table 310 that may be stored in memory 308. The table 310a may include a physical address for each IPM controller in the system. This table 310a containing physical address information may be constructed by the controller 308 of the IPMB switch system during an initial discovery phase. For example, the IPMB switch system 102 may broadcast a discovery message, e.g., a “IPMI Get Device ID command,” to all the IPM controllers in the system to determine the presence and address of each IPM controller. Hence, the address table would list each IPM controller 206, 208, 210, 212, 214, 216 in the system with its associated physical address as illustrated in table 310a.

Fault Isolation

All of the topologies of FIGS. 2A through 2C provide for fault isolation due to either IPM controller failure, IPMB link failure, or both. The failed IPM controller or IPMB link may be detected and isolated by the switch system. For instance, in the star topology of FIG. 2A, the IPM controller 206, or the IPMB link 230, or both may fail. Such failure may be detected by the IPMB switch system 102a after repeated attempts to communicate with such IPM controller 206 via such IPMB link 230 prove unsuccessful. Other parameters, such as the voltage supply level to the IPM controller 206, may be sensed and a signal representative of such condition or conditions provided to the IPMB switch 202 such that the switch system 102a may detect a failure if the sensed parameter is outside an expected range of acceptable values. Once failure is detected, the IPMB switch system 102a may then isolate such failure by preventing further communication with such IPM controller 206 via such IPMB link 230. However, the switch system 102a may advantageously still permit communication between the other IPM controllers 208, 210, 212, 214, 216 via the associated IPMB links. Hence, only communication with IPM controller 206 is lost while communication between the remainder of the IPM controllers may continue to be routed by the IPMB switch system 102a.

Active-Standby and Active-Active Modes

The IPMB switch system 102c of FIG. 2C having the dual-dual star topology may be operated in an active-standby mode or an active-active mode. The IPMB link 260 between each IPMB switch 202 and 204 may be utilized to perform mode negotiations for Active-Standby and Active-Active modes and may also be utilized to exchange health and state information of each IPMB switch 202, 204 to each other. In an active-standby mode, the first IPMB switch 202 may be operated in an active mode. That is, the first switch 202 may be capable of routing messages between the IPM controllers 206, 208, 210, 212, 214, 216. The second switch 204 may then operate in a standby mode not routing any messages between any of the IPM controllers, but standing by and capable of assuming an active mode in case of failure of the first IPMB switch 202.

As such, the Active-Standby mode provides for increased reliability due to switch redundancy. The active switch and the standby switch may be automatically chosen during an initial negotiation or configuration process. The IPMB switch with the lower IPMB address may be automatically selected as the active switch in the Active-Standby mode. The active and standby switch may alternatively be user configured, e.g., via the user interface system 116 of FIG. 1. For instance, in an Active-Standby mode where the first IPMB switch 202 is in an active mode and the second IPMB switch 204 is in a standby mode, IPMB link 230 between IPM controller 206 and the first IPMB switch 202 may fail. Changing the IPMB switch 204 from the standby mode to the active mode would enable IPM controller 206 to communicate with other IPM controllers via the second IPMB switch 204. In this instance, the first IPMB switch 202 may remain in the active mode or may switch to a standby mode.

The first and second IPMB switches 202 and 204 of the dual-dual star topology of FIG. 2C may also be operated in an active-active mode. In this active-active mode, both switches 202 and 204 may route messages between source and destination IPM controllers. In such an active-active mode, link aggregation may effectively increase the bandwidth between IPM controllers. For example, IPM controller 206 could communicate with IPM controller 214 via IPMB link 230, the first IPMB switch 202 and IPMB link 246. The same IPM controller 206 could also communicate with IPM controller 214 via IPMB link 232, the second IPMB switch 204, and IPMB link 248. As such, such link aggregation increases the data bandwidth between iPM controllers while also providing for redundancy and flexibility in the case of IPMB link, IPM controller, and/or IPMB switch failures. For example, if one IPMB link to one IPM controller fails, the IPM controller would still be able to communicate with other IPM controllers utilizing the other IPMB link to the other IPMB switch.

Dual Redundant IPMB Links

The embodiment of FIG. 2B may have dual IPMB links between each IPM controller 206, 208, 210, 212, 214, 216 and each IPMB switch 202, 204. For example, between IPM controller 206 and IPMB switch 202 dual IPMB links 230 and 270 may be present. Each IPMB link 230, 232, 234, 236, 238, 240, 242, 244, 246, 248, 250, and 252 may therefore each have an associated redundant link 270, 272, 274, 276, 278, 280, 282, 284, 286, 288, 290, and 292.

Similarly, the embodiment of FIG. 2C may also have dual IPMB links between each IPM controller 206, 208, 210, 212, 214, 216 and each IPMB switch 202, 204. In addition, dual IPMB links 260 and 262 may couple each IPMB switch 202 and 204 to each other. The IPMB switch system may have intelligence to forward messages between IPM controllers 206, 208, 210, 212, 214, 216 through either one or both of the dual IPMB links. The dual links provide for additional redundancy such that when one IPMB link fails, the dual redundant link may still be available for communication. The switch system may also detect a failure of one of the dual IPMB links and send an alert type message. However, advantageously the failure of one of the dual IPMB links need not impede communication if the other redundant IPMB link is available.

Zoning

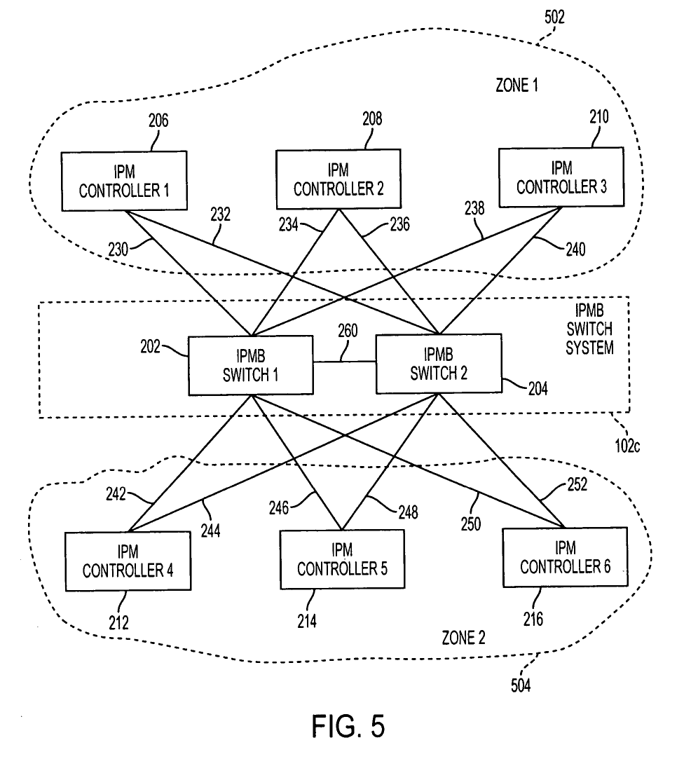

FIG. 5 is a block diagram of the topology of FIG. 2C segmented into two zones 502 and 504 of IPM controllers or virtual IPMB networks by the switch system 102c. Zone 502 may include IPM controllers 206, 208, and 210 while zone 504 may include IPM controllers 212, 214, and 216. As used herein, a “zone” is a group of one or more IPM controllers. Any one IPM controller may also be in one or more zones. In other words, the zones may overlap without departing from this embodiment. For example, IPM controller 206 is illustrated as being only in the first zone 502. However, the IPM controller 206 may also be in another zone, e.g., the second zone 504.

Zones may be designated by modifying the address table (table 130a of FIG. 4) previously created with a particular zone designation, e.g., IPM controllers 206, 208, and 210 with zone 1 and IPM controllers 212, 214, and 216 with zone 2. Once zones are designated and enabled, the IPMB switch system 102 may control communication between IPM controllers in the various zones. Such communication may be controlled by the IPMB switch system by restricting communication between IPM controllers in one zone with the IPM controllers of any other zone. For example, the IPMB switch system 102 may permit communication of IPMI messages between IPM controller 206 and the other IPM controllers 208 and 210 within the first zone 502, but prohibit communication between IPM controller 206 and any IPM controllers 212, 214, and 216 in the second zone 504. Hence, the IPMB switch system can enable the creation of multiple zones or virtual IPMB networks. The designation of such zones 502 and 504 may be modified or deleted, e.g., by changes to the zone designation in the address table 130a.

Such zoning may be utilized in a racked or chassis system to isolate one board IPM controller from other IPM controllers. For example, there may be two or more tenants in a racked or chassis system on different boards in the same chassis. In a conventional bussed system, one board from one tenant may undesirably communicate with another board from another tenant creating security concerns and possibly derogating the system. Each tenant's board may be included in a separate zone to enable each to communicate with acceptable IPM controllers such as the BMC for the chassis and to prevent communication between the IPM controllers of each tenant's board.

Address Translation

The IPMB switch system 102 may also be capable of performing IPMB address translation to accommodate IPM controllers with similar physical addresses. The table 130a of FIG. 3 may be modified to include a column for a virtual address for each IPM controller in the system as necessary. The physical address of each IPM controller may also be detailed in the physical address column. If an IPM controller has an identical physical address as another IPM controller, the IPMB switch system may create a virtual address for one of those IPM controllers and store such virtual address in the table 130a.

For instance, if IPM controllers 208 and 210 have the same physical address “b”, the switch system may assign a virtual address “b1” to one IPM controller that is different from the physical address. The IPMB switch system may automatically detect and assign such virtual addresses to IPM controllers with the same physical address. The IPMB switch system may then be able to route messages among various IPM controllers with the same physical address. An incoming message having an associated virtual address may be converted by the IPMB switch system to its associated physical address before forwarding the message. With the address translation feature, boards may be designed with various IPM controllers having the same physical address to provide for product standardization and design flexibility.

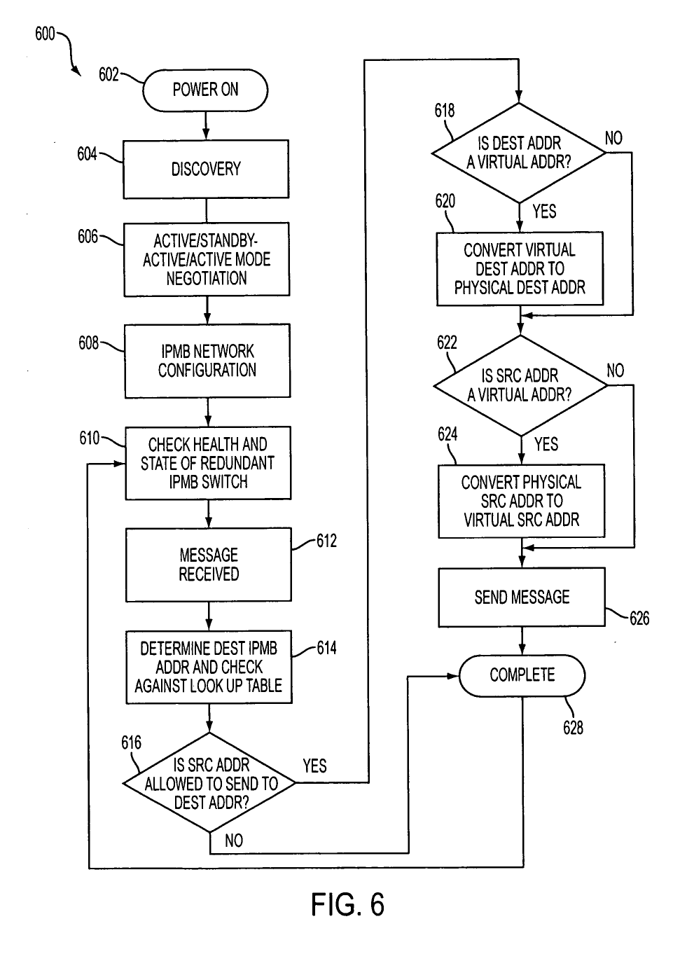

FIG. 6 is a flow chart 600 illustrating operational flow of the dual-dual star switch topology of FIG. 2C. After the IPMB switch system 102c is powered on in operation 602, a discovery operation 604 may take place. The discovery operation may include the IPMB switch system 102c broadcasting a discovery message, e.g., the “IPMI Get Device ID command,” to each IPM controller in the system to determine the presence and address of each IPM controller.

Operation 606 may then proceed where Active-Standby and Active-Active mode negotiation between each IPMB switch 202 and 204 via IPMB link 260 may take place. Operation 608 may then configure the IPMB network of IPM controllers into various zones as desired. This may occur by including a column in table 130a for a particular zone for each IPM controller. The health and state of the redundant IPMB switch (IPMB switches 202 and 204) may be checked in operation 610 utilizing the IPMB link 260 in one instance.

A message to be sent from a source IPM controller to a destination IPM controller may be received by one of the IPMB switches 202 or 204 in operation 612. Once the message is received, the IPMB switch may, e.g., by analyzing a routing portion of the incoming message, determine the destination IPM controller in operation 614. The destination IPM physical address may then also be determined, e.g., from the table 130a previously constructed during the discovery operation 604.

The IPMB switch system may then determine if the source address is allowed to send a message to the specified destination address in operation 616, e.g., by checking the presence of any zones created during operation 608. If the source address is not allowed to send to the destination address, then the message is not sent and the process is complete 628. If the source address is allowed to send to the destination address, the IPMB switch system may determine if the destination address is a virtual address in operation 618. This may occur by accessing and looking up the specified destination address in a table such as from table 130a of FIG. 4.

If the destination address is a virtual address, then the IPMB switch system may convert the virtual destination address to an associated physical destination address in operation 620, e.g. by reference to the table 130a. If the destination address is not a virtual address, the process bypasses the conversion operation 620. The IPMB switch system may then determine if the source address is a virtual address in operation 622. If it is, then the IPMB switch system may convert the physical source address to a virtual source address in operation 624. If the source address is not a virtual address, the process may bypass the conversion operation 626 and the message may then be sent from the IPMB switch system to the destination IPM controller in operation 626 and the process may be completed 628.

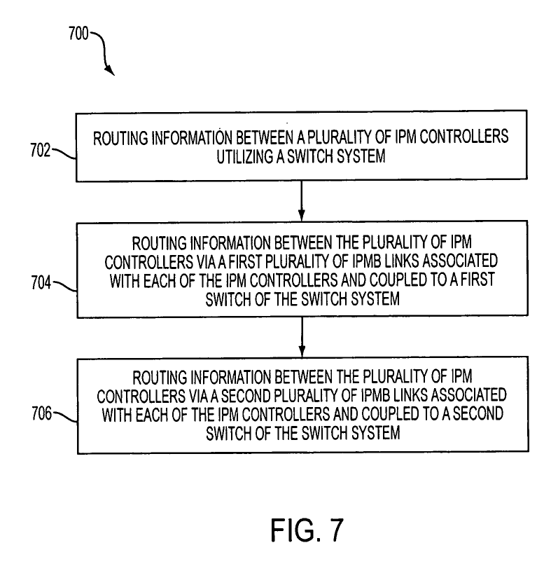

FIG. 7 is a flow chart of operations 700 consistent with an embodiment. Operation 702 may comprise routing information between a plurality of IPM controllers utilizing a switch system. Operation 704 may include routing information between the plurality of IPM controllers via a first plurality of IPMB links associated with each of the IPM controllers and coupled to a first switch of the switch system. Operation 706 may include routing information between the plurality of IPM controllers via a second plurality of IPMB links associated with each of the IPM controllers and coupled to a second switch of the switch system.

It will be appreciated that the functionality described for all the embodiments described herein, may be implemented using hardware, firmware, software, or a combination thereof.

Thus, one embodiment may comprise a bus topology. The bus topology may comprise an IPMB switch system capable of routing information between a plurality of IPM controllers. The IPMB switch system may comprise a first and second IPMB switch. The first IPMB switch may be coupled to each of the plurality of IPM controllers via a first associated plurality of IPMB links, and the second IPMB switch may be coupled to each of the plurality of IPM controllers via a second associated plurality of IPMB links.

Another embodiment may comprise an article. The article may comprise a machine readable medium having stored thereon instructions that when executed by a machine result in the machine performing operations comprising: routing information between a plurality of IPM controllers utilizing a switch system. The switch system may comprise a first and second IPMB switch. The first IPMB switch may be coupled to each of the plurality of IPM controllers via a first associated plurality of IPMB links, and the second IPMB switch may be coupled to each of the plurality of IPM controllers via a second associated plurality of IPMB links

Another embodiment may comprise a system. The system may comprise a plurality of IPM controllers, one of the plurality of IPM controllers being a baseboard management controller (BMC). The BMC may be capable of being coupled to a bus. The system may also comprise an IPMB switch system capable of routing information between the plurality of IPM controllers. The IPMB switch system may comprise a first and second IPMB switch. The first IPMB switch may be coupled to each of the plurality of IPM controllers via a first associated plurality of IPMB links, and the second IPMB switch may be coupled to each of the plurality of IPM controllers via a second associated plurality of IPMB links

Advantageously, in these embodiments, the IPMB switch system is cable of routing messages between IPM controllers. In addition, when two IPMB switches are utilized as in the dual star topology of FIG. 2B or the dual-dual star topology of FIG. 2C, link aggregation benefits may also be achieved as each IPM controller may communicate information to another IPM controller via different IPMB links and different IPMB switches.

In addition, the IPMB switch system having two IPMB switches may also provide redundancy benefits. For example, if one IPMB link coupling one IPM controller to one of the IPMB switches fails, the other IPMB link coupling that IPM controller to the other IPMB switch may be utilized. Furthermore, the IPMB switch system may also provide for fault isolation. If one IPM controller or an IPMB link to that IPM controller fails, the faulted IPM controller or IPMB link can be detected and isolated by the IPMB switch. Hence, only communication with the failed IPM controller is lost while communication between the remainder of the IPM controllers remains unaffected.

Furthermore, the IPMB switch system may create a plurality of zones or virtual IPM networks in order to control communication between IPM controllers of different zones. In a conventional system, such zoning or virtualization may not be possible. Such zoning may be utilized in a racked or chassis system to isolate one board IPM controller from other IPM controllers.

Yet further, the IPMB switch system may create virtual addresses for those IPM controllers having identical physical addresses. As such, multiple IPM controllers may have the same physical address. Physical and virtual address translation may be accomplished by the IPMB switch system.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Other modifications, variations, and alternatives are also possible. Accordingly, the claims are intended to cover all such equivalents.

What is claimed is:

1. A bus topology comprising:
an intelligent platform management bus (IPMB) switch system capable of routing information between a plurality of intelligent platform management (IPM) controllers, said IPMB switch system comprising a first and second IPMB switch, said first IPMB switch coupled to each of said plurality of IPM controllers via a first associated plurality of IPMB links, and said second IPMB switch coupled to each of said plurality of IPM controllers via a second associated plurality of IPMB links.

2. The bus topology of claim 1, wherein said first IPMB switch is coupled to said second IPMB switch via a first IPMB link.

3. The bus topology of claim 2, wherein said first and second IPMB switch are operated in an active-standby mode where said first IPMB switch is in an active mode capable of routing said information between said plurality of IPM controllers on said first associated plurality of IPMB links and said second IPMB switch is in a standby mode capable of assuming said active mode in case of a failure of said first IPMB switch to route said information between said plurality of IPM controllers on said second associated plurality of IPMB links.

4. The bus topology of claim 2, wherein said first and second IPMB switch are operated in an active-active mode where both said first and second switch route said information between said plurality of IPM controllers on said first and second associated plurality of IPMB links.

5. The bus topology of claim 1, wherein said switch system is capable of designating at least one zone, said at least one zone comprising at least a first IPM controller of said plurality of IPM controllers, said switch system further capable of restricting communication between said first IPM controller in said at least one zone and other IPM controllers.

6. The bus topology of claim 1, wherein each of said plurality of IPM controllers has an associated physical address, and wherein a first and second IPM controller have an identical physical address, and wherein said switch system is capable of creating a first virtual address for said first IPM controller, said first virtual address being different than said associated physical addresses.

7. The bus topology of claim 1, wherein said switch system is capable of detecting an inability of at least one of said IPM controllers to communicate with said switch system, said switch system is further capable of isolating said at least one IPM controller and routing said information between a remainder of said IPM controllers.

8. The bus topology of claim 1, wherein said first IPMB switch is also coupled to each of said plurality of IPM controllers via a third associated plurality of IPMB links, said third associated plurality of IPMB links being a redundant set of IPMB links for said first associated plurality of IPMB links, wherein said second IPMB switch is also coupled to each of said plurality of IPM controllers via a fourth associated plurality of IPMB links, said fourth associated plurality of IPMB links being a redundant set of IPMB links for said second associated plurality of IPMB links.

9. A method comprising:
routing information between a plurality of Intelligent Platform Management (IPM) controllers utilizing a switch system, said switch system comprising a first and second IPMB switch, said first IPMB switch coupled to each of said plurality of IPM controllers via a first associated plurality of IPMB links, and said second IPMB switch coupled to each of said plurality of IPM controllers via a second associated plurality of IPMB links.

10. The method of claim 9, further comprising coupling said first and second IPMB switch in a dual-dual star topology,

11. The method of claim 10, further comprising:
operating said first IPMB switch in an active mode, said first IPMB switch in said active mode capable of routing said information between said plurality of IPM controllers on said first associated plurality of IPMB links; and
operating said second IPMB switch in a standby mode, said second IPMB switch in said standby mode capable of assuming an active mode in case of a failure of said first IPMB switch, said second IPMB switch in said active mode capable of routing said information between said plurality of IPM controllers on said second associated plurality of IPMB links.

12. The method of claim 10, further comprising:
operating said first IPMB switch in an active mode, said first IPMB switch in said active mode capable of routing said information between said plurality of IPM controllers on said first associated plurality of IPMB links; and
operating said second IPMB switch in an active mode simultaneously with said first IPMB switch, said second IPMB switch in said active mode capable of routing said information between said plurality of IPM controllers on said second associated plurality of IPMB links.

13. The method of claim 9, further comprising:
designating at least one zone, said at least one zone comprising at least one IPM controller of said plurality of IPM controllers; and
restricting communication between said at least one IPM controller in said at least one zone and other IPM controllers not in said zone.

14. The method of claim 13, wherein said restricting communication comprises preventing any communication between said at least one IPM controller in said at least one zone and said other IPM controllers not in said zone.

15. The method of claim 9, further comprising assigning a virtual address to an IPM controller with a similar physical address as another IPM controller.

16. The method of claim 9, further comprising isolating a fault, said fault being an inability of one of said plurality of IPM controllers to communicate with said switch system and said method further comprising routing of said information between a remainder of said IPM controllers.

17. The method of claim 9, wherein said first IPMB switch is also coupled to each of said plurality of IPM controllers via a third associated plurality of IPMB links, said third associated plurality of IPMB links being a redundant set of IPMB links for said first associated plurality of IPMB links, wherein said second IPMB switch is also coupled to each of said plurality of IPM controllers via a fourth associated plurality of IPMB links, said fourth associated plurality of IPMB links being a redundant set of IPMB links for said second associated plurality of IPMB links, and wherein said routing operation utilizes one of said third associated plurality of IPMB links upon failure of an associated one of said first associated plurality of IPMB links.

18. An article comprising:
a machine readable medium having stored thereon instructions that when executed by a machine result in the machine performing operations comprising:
routing information between a plurality of Intelligent Platform Management (IPM) controllers utilizing a switch system, said switch system comprising a first and second IPMB switch, said first IPMB switch coupled to each of said plurality of IPM controllers via a first associated plurality of IPMB links, and said second IPMB switch coupled to each of said plurality of IPM controllers via a second associated plurality of IPMB links.

19. The article of claim 18, wherein said operations further comprise coupling said first and second IPMB switch in a dual-dual star topology,

20. The article of claim 19, wherein said operations further comprise:
operating said first IPMB switch in an active mode, said first IPMB switch in said active mode capable of routing said information between said plurality of IPM controllers on said first associated plurality of IPMB links; and
operating said second IPMB switch in a standby mode, said second IPMB switch in said standby mode capable of assuming an active mode in case of a failure of said first IPMB switch, said second IPMB switch in said active mode capable of routing said information between said plurality of IPM controllers on said second associated plurality of IPMB links.

21. The article of claim 18, wherein said operations further comprise:
operating said first IPMB switch in an active mode, said first IPMB switch in said active mode capable of routing said information between said plurality of IPM controllers on said first associated plurality of IPMB links; and
operating said second IPMB switch in an active mode simultaneously with said first IPMB switch, said second IPMB switch in said active mode capable of routing said information between said plurality of IPM controllers on said second associated plurality of IPMB links.

22. The article of claim 18, wherein said operations further comprise:
designating at least one zone, said at least one zone comprising at least one IPM controller of said plurality of IPM controllers; and
restricting communication between said at least one IPM controller in said at least one zone and other IPM controllers not in said zone.

23. The article of claim 22, wherein said restricting communication comprises preventing any communication between said at least one IPM controller in said at least one zone and said other IPM controllers not in said zone.

24. The article of claim 18, wherein said operations further comprise assigning a virtual address to an IPM controller with a similar physical address as another IPM controller.

25. The article of claim 18, wherein said operations further comprise isolating a fault, said fault being an inability of one of said plurality of IPM controllers to communicate with said switch system and said operations further comprise routing of said information between a remainder of said IPM controllers.

26. A system comprising:
a plurality of intelligent platform management (IPM) controllers, one of said plurality of IPM controllers being a baseboard management controller (BMC), said BMC being capable of being coupled to a bus; and
a intelligent platform management bus (IPMB) switch system capable of routing information between said plurality of IPM controllers, said IPMB switch system comprising a first and second IPMB switch, said first IPMB switch coupled to each of said plurality of IPM controllers via a first associated plurality of IPMB links, and said second IPMB switch coupled to each of said plurality of IPM controllers via a second associated plurality of IPMB links.

27. The system of claim 26, wherein said first IPMB switch is coupled to said second IPMB switch via a first IPMB link.

28. The system of claim 26, wherein said switch system is capable of designating at least one zone, said at least one zone comprising at least a first IPM controller of said plurality of IPM controllers, said switch system further capable of restricting communication between said first IPM controller in said at least one zone and other IPM controllers.

29. The system of claim 26, wherein each of said plurality of IPM controllers has an associated physical address, and wherein a first and second IPM controller have an identical physical address, and wherein said switch system is capable of creating a first virtual address for said first IPM controller, said first virtual address being different than said associated physical addresses.

30. The system of claim 26, wherein said switch system is capable of detecting an inability of at least one of said IPM controllers to communicate with said switch system, said switch system is further capable of isolating said at least one IPM controller and routing said information between a remainder of said IPM controllers.

31. The system of claim 26, wherein said first IPMB switch is also coupled to each of said plurality of IPM controllers via a third associated plurality of IPMB links, said third associated plurality of IPMB links being a redundant set of IPMB links for said first associated plurality of IPMB links, wherein said second IPMB switch is also coupled to each of said plurality of IPM controllers via a fourth associated plurality of IPMB links, said fourth associated plurality of IPMB links being a redundant set of IPMB links for said second associated plurality of IPMB links.
